(19) United States
(12) Patent Application Publication
(10) Pub. No.: US 2007/0267609 A1
(43) Pub. Date: Nov. 22, 2007

(54) Composite Materials Comprising Plastics and Wood

(75) Inventors: Manfred Ratzsch, Wilhering (AT); Huong-Lan Nguyen, Linz (AT); Uwe Muller, Luftenberg (AT); Harald Zobl, Geboltskirchen (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI Agrolinz Melamine International GMBH, Linz (AT)

(21) Appl. No.: 10/565,463

(22) PCT Filed: Jul. 21, 2004
(86) PCT No.: PCT/EP04/08399

§ 371 Date: Mar. 29, 2007

(30) Foreign Application Priority Data
Jul. 22, 2003 (DE) 10333893.4

(51) Int. Cl. C09K 21/00

(52) U.S. Cl. 252/607; 264/211.23

(57) ABSTRACT

The invention relates to composite materials, comprising plastics and wood, with 55 to 90 mass % of wood in the form of sawdust, wood fibres, and/or wood chippings and 45 to 10 mass % of partly crosslinked melamine resin ethers or mixtures of partly crosslinked thermoplastics and crosslinked melamine resin ethers, whereby the plastics in the composite materials can be in the form of a foam. Said materials can be produced by homogenization of the components in the extruder, pre-impregnation of wood with melamine resins in the screw mixer and subsequent homogenization of the components in the extruder, or by a sinter method, each followed by a subsequent moulding to give the composite material. The composite materials are suitable for application in building and in sport and leisure applications.

The invention relates to composite materials comprising plastics and wood and to a process for their production.

Composite materials comprising plastics and wood are known.

Composite materials comprising wood and thermoplastics are known. EP 1 172 404 A1 describes composites composed of polypropylene, polyethylene or polystyrene, with a wood fiber content of from 20 to 80% by weight. The effect of elastomers such as ethylene-propylene-diene terpolymers on the impact strength behavior of wood fiber-filled polypropylene was investigated by Oksman (Int. Conf. Woodfiber-Plast. Compos. 4th 1997, 144-145). JP 2001 121 654 A2 describes laminates composed of polyolefin-wood powder blends which in the inner and outer ply comprise polyolefin/wood powder in a mixing ratio of 1:2. Likewise known is the surface treatment of wood powder with diisocyanates in connection with the production of wood-polypropylene compounds (KR 9 608 119 A2). Disadvantages affecting the composite materials comprising thermoplastics and wood are the limited strength and toughness as a consequence of the low compatibility of the apolar polyolefins with the wood component.

The use of wood powder as a filler in melamine compression molding compounds is described in JP 52 005 854 A2 and Ullmann's Encyclopedia of Industrial Chemistry (1987), Vol. A2, p. 134. Disadvantages associated with these composite materials are the costly and inconvenient production, by the compression molding technology, and the low flexibility of the composite materials.

Additionally known is the impregnation of wood fiber/synthetic fiber mixtures with melamine resins as part of the production of composite boards (JP 27 25 228 B2) and the use of melamine-formaldehyde resins as impregnating resins for wood products (SE 9 803 828 A, JP 2000 108 107 A).

An objective of the invention are composite materials which comprise plastics and wood and can be produced by thermoplastic processing techniques, and which possess improved materials properties.

The object of the invention is achieved by means of composite materials comprising plastics and wood, the composite materials having, in accordance with the invention, a proportion of wood which has been dispersed in the form of particles in the crosslinked plastics, and the crosslinked plastics being crosslinked melamine resin ethers or mixtures composed of from 10 to 90% by weight of partially crosslinked thermoplastics and of from 90 to 10% by weight of crosslinked melamine resin ethers.

One advantageous example of a composite material of the invention has the following composition:
A) from 55 to 90% by weight of wood in the form of wood flour, wood particles, wood granules, wood fibers, and/or wood shavings, and
B) from 45 to 10% by weight of crosslinked plastics,
the crosslinked plastics being
B1) crosslinked melamine resin ethers, or
B2) mixtures of
   from 10 to 90% by weight of partially crosslinked thermoplastics, and
   from 90 to 10% by weight of crosslinked melamine resin ethers,
it being possible for the crosslinked melamine resin ethers and the partially crosslinked thermoplastics to be present in the composite materials in foamed form, and for the composite materials to contain from 3 to 10% by weight of flame retardant, from 0.1 to 2% by weight of pigments, from 0.1 to 5% by weight of stabilizers, and/or from 0.1 to 5% by weight of auxiliaries, in each case based on the entirety of wood and plastics. These parameters may be fulfilled together or individually.

The composite materials are preferably sheets, profiles, or injection moldings.

The particulate wood, in particular in the form of wood flour, wood particles, wood fibers and/or wood shavings, in the composite materials may be composed of softwood and/or of hardwood.

Suitable wood flour in the composite materials comprises wood flours possessing an average particle diameter of from 0.01 to 0.5 mm. Suitable wood particles are those with an average diameter of from 0.5 to 5 mm. Suitable wood granules are those possessing on average a particle diameter of from 1 to 5 mm. Suitable wood fibers in the composite materials are wood fibers possessing an average length of from 0.05 to 1 mm and a length/thickness ratio of from 2:1 to 20:1. Suitable wood shavings are those with a length of from 1 to 5 mm and a thickness of from 0.5 to 2 mm.

Composite materials composed of from 65 to 80% by weight of wood in the form of mixtures of wood fibers and wood shavings in a ratio of from 1:10 to 10:1 and 35 to 20% by weight of crosslinked plastics are preferred.

In the crosslinked melamine resin ethers the molar ratio of aldehyde component to melamine component is preferably 1.5:1 to 4:1.

Preferred crosslinked melamine resin ethers are crosslinked etherified melamine resin condensates which are free from hydroxymethyleneamino groups bonded to the triazine rings of the melamine resin condensate, and from —NH—CH₂—O—CH₂—NH— groups linking triazine rings, and in which the non-crosslinked etherified melamine resin condensates have been effected via etherification of the hydroxymethylamino groups of the non-etherified melamine resin condensates via C₁-C₁₈ alcohols and/or via polyols of the type represented by diols, triols, and/or tetrols with molecular weights of from 62 to 20 000, and in which the non-crosslinked etherified melamine resin condensates have been hardened thermally and/or via acidifier.

The partially crosslinked thermoplastics are preferably partially crosslinked ethylene-vinyl acetate copolymers, partially crosslinked partially hydrolyzed ethylene-vinyl acetate copolymers, partially crosslinked thermoplastic polyurethanes, partially crosslinked high-molecular-weight aliphatic, aromatic-aliphatic polyethers, and/or partially crosslinked aliphatic and/or aromatic-aliphatic polyesters, in particular partially crosslinked polycaprolactones, and/or unsaturated polyesters.

Suitable partially crosslinked ethylene-vinyl acetate copolymers in the composite materials are partially crosslinked copolymers whose vinyl acetate content is from 4 to 50% by weight.

Suitable partially crosslinked partially hydrolyzed ethylene-vinyl acetate copolymers in the composite materials are partially crosslinked copolymers whose initial vinyl acetate content is from 4 to 50% by weight, and in which from 5 to 50 mol % of the vinyl acetate groups have been hydrolyzed to give vinyl alcohol groups.

Another preferred constitution of the composite materials is composed of from 65 to 80% by weight of wood in the form of mixtures composed of wood fibers and of wood shavings in a ratio of from 1:10 to 10:1 and from 35 to 20% by weight of crosslinked plastics in the form of mixtures composed of partially crosslinked EVA copolymers whose vinyl acetate content is from 25 to 40% by weight and of crosslinked melamine resin ethers in a mixing ratio of from 2:1 to 1:5.

Examples of partially crosslinked polyurethanes which can be present in the composite materials are partially crosslinked thermoplastic polyurethanes based on hexamethylene diisocyanate as diisocyanate component and on diol components such as butanediol, hexanediol, dodecanediol, and/or on polyalkylene glycols.

If the plastics in the composite materials are in foamed form, the density of the composite materials is preferably from 0.6 to 1.0 g/cm³.

Examples of suitable flame retardants which can be present in the inventive composite materials are ammonium polyphosphate, melamine cyanurate, boron trioxide, boric acid, ammonium borate, and zinc borate.

Examples of suitable pigments which can be present in the inventive composite materials are iron oxide, isoindoline pigments containing ester groups, anthracene fluorescent dyes, carbazole dioxazine, and delta-indanthrone blue pigment.

The stabilizers present in the composite materials are preferably UV absorbers and/or free-radical scavengers.

Examples of suitable UV absorbers which can be present in the inventive composite materials are 2-(2-hydroxy-3-tert-butyl-5-methylphenyl)benzotriazole, 2,4-di-hydroxybenzophenone, and sodium 3-(2H-benzotriazol-2-yl)-5-sec-butyl-4-hydroxybenzene sulfate.

Examples of suitable free-radical scavengers which can be present in the inventive composite materials are bis[2,2,6,6-tetramethyl-1-(octyloxy)-4-piperidinyl]sebacate, bis(2,2,6,6-tetramethyl-4-piperidinyl) sebacate, N,N′-(2-hydroxyphenyl)ethanediamide, and N,N′-diformyl-N,N′-di(1-oxyl-radical-2,2,6,6-tetramethyl-4-piperidinyl)-1,6-hexanediamine.

The auxiliaries present in the composite materials are preferably lubricants of the type represented by zinc stearate, calcium stearate, and/or magnesium stearate, and/or release agents of the type represented by talc, aluminum oxide, sodium carbonate, calcium carbonate, silica, and/or polytetrafluoroethylene powder.

In one variant, a composite material comprising plastics and wood is produced by an extruder process where in a first stage of the process in a first extruder segment a melt mixture composed of melamine resin ethers, wood, or thermoplastics is prepared, the melt mixture is devolatilized after homogenization, and, in a second extruder segment, hardener, thermally decomposing free-radical generator, and/or blowing agent are fed into the melt mixture, and are homogenized in the melt mixture, where flame retardants, pigments, stabilizers, and/or auxiliaries can be fed in the first and/or second extruder segment, and in a second stage of the process, the wood-containing melt mixture is either heated in a third extruder segment, discharged via a die with crosslinking and, if appropriate, foaming, and drawn off in the form of a semifinished product, or is discharged from the extruder, and pelletized, and the pellets in a third stage of the process are processed in presses, extruders, or injection-molding machines with crosslinking and, if appropriate, foaming to give semifinished products or molded materials.

An example of one advantageous embodiment of this process is stated below.
Composite materials as claimed in claim 1 are produced in the extruder process where the crosslinked melamine resin ethers and the partially crosslinked thermoplastics can be present in foamed form in the composite materials, and the composite materials may comprise from 3 to 10% by weight of flame retardant, from 0.1 to 2% by weight of pigments, from 0.1 to 5% by weight of stabilizers, and/or from 0.1 to 5% by weight of auxiliaries, in each case based on the entirety of wood and plastics, and in this process, in the
a) first stage of the process, in extruders whose length is from 30 to 60 D, which have side-feed equipment for solid and liquid substances and have a vacuum devolatilization system, in a first extruder segment, melt mixtures composed of melamine resin ethers whose weight-average
molecular weights are from 1500 to 200 000 and whose molar melamine/formaldehyde ratio is from 1:1.5 to 1:4, wood in the form of wood flour, wood particles, wood granules, wood fibers, and/or wood shavings whose residual moisture level is up to 10% by weight and, if appropriate, thermoplastics, at melt temperatures of from 110 to 170° C., where the components of the mixture can be fed together into the feed hopper or wood can be fed into the plastics melt after melting of the melamine resin ether and, if appropriate, of the thermoplastic, by way of side-feed equipment, or wood can be fed into the thermoplastic melt after melting of the thermoplastic by way of side-feed equipment and then the melamine resin ether can be fed to the wood-containing thermoplastic melt by way of side-feed equipment, the melt mixture is devolatilized after homogenization, and, in the second extruder segment, at melt temperatures of from 100 to 150° C., from 0.1 to 2% by weight, based on the melamine resin ether, of hardener, from 0.1 to 2% by weight, based on the thermoplastics, of thermally decomposing free-radical generators, and, if appropriate, from 0.2 to 4% by weight, based on the entirety of thermoplastic and melamine resin ether, of blowing agents, are fed into the melt mixture, and are homogenized in the melt mixture, where a form in which blowing agents, hardeners, and/or thermally decomposing free-radical generators can be used is that of a from 60 to 90% by weight of thermoplastic-containing masterbatch, and where from 3 to 10% by weight of flame retardant, from 0.1 to 2% by weight of pigment, from 0.1 to 5% by weight of stabilizers, and/or from 0.1 to 5% by weight of auxiliaries, based in each case on the entirety of melamine resin ether, wood, and thermoplastic can be fed into the extruder in the first and/or second extruder segment, and in the
b) second stage of the process, the melt mixture comprising wood in the form of wood flour, wood particles, wood granules, wood fibers, and/or wood shavings is either heated in a third extruder segment at temperatures of from 150 to 240° C., discharged via a die with crosslinking and, if appropriate, foaming, and drawn off in the form of a semifinished product,
or is discharged from the extruder, and pelletized, and the pellets of the molding composition in the
c) third stage of the process are processed at temperatures of from 150 to 240° C. in presses, extruders, or injection-molding machines with crosslinking and, if appropriate, foaming to give semifinished products or molded materials.

Preferred extruders used in the extruder process are twin-screw extruders or extruders with a plunger screw.

Another advantageous process for production of composite materials comprising plastics and wood consists in producing the composite material by a pre-impregnation process where, prior to the first stage of the process, wood is impregnated, in mixers, with solutions or dispersions of melamine resin condensates in water or mixtures composed of water and C₁-C₄ alcohols, and is dried, where the melamine resin condensates are etherified melamine resin condensates and/or are melamine resin condensates partially etherified with C₁-C₄ alcohols, the weight-average molecular weights of the condensates being from 150 to 50 000 and their molar melamine/formaldehyde ratio being from 1:1.5 to 1:4, and the melamine resin condensates comprise, if appropriate, up to 3% by weight of hardener, based on the melamine resin condensates, and then the melt mixture in the first stage of the process composed of the wood pre-impregnated with melamine resins and also of
melamine resin ethers or
thermoplastics or
mixtures composed of melamine resin ethers and thermoplastics
   is prepared.

In the first stage of the process it is possible, by way of example, for wood in the form of wood flour, wood particles, wood granules, wood fibers, and/or wood shavings whose residual moisture level is up to 10% by weight to be impregnated in mixers at from 80 to 102° C. with solutions or dispersions of melamine resin condensates in water or mixtures composed of from 10 to 90% by weight of water and from 90 to 10% by weight of C₁-C₄ alcohols whose solids content is from 20 to 80% by weight, and to be dried, the melamine resin absorption by the wood solids being from 2 to 20% by weight, based on the dry wood solids, the melamine resin condensates being etherified melamine resin condensates and/or melamine resin condensates partially etherified with C₁-C₄ alcohols, the weight-average molecular weights of the condensates being from 150 to 50 000 and their molar melamine/formaldehyde ratio being from 1:1.5 to 1:4, and
the proportion of the hydroxy groups not etherified with C₁-C₄ alcohols in the partially etherified melamine resin condensates is from 5 to 75 mol %, based on the entirety of hydroxy groups and C₁-C₄ alkoxy groups in the melamine resin precondensates partially etherified with C₁-C₄ alcohols,
   and
the melamine resin condensates can comprise up to 3% by weight of hardener, based on the melamine resin condensates,
   and
in the second stage of the process, in extruders whose length is from 30 to 60 D, which have side-feed equipment for solid and liquid substances, and have a vacuum devolatilization system,
   in a first extruder segment, melt mixtures which comprise wood pre-impregnated with melamine resins in the form of wood flour, wood particles, wood granules, wood fibers, and/or wood shavings, and which are composed of melamine resin ethers whose weight-average molecular weights are from 1500 to 200 000 and whose molar melamine/formaldehyde ratio is from 1:1.5 to 1:4, or mixtures composed of melamine resin ethers and of thermoplastics, or are composed of thermoplastics, are prepared at melt temperatures of from 110 to 170° C., where the components of the mixture can be fed together into the feed hopper, or pre-impregnated wood can be fed into the plastics melt after melting of the melamine resin ether and/or of the thermoplastic by way of side-feed equipment, or pre-impregnated wood can be fed into the thermoplastic melt after melting of the thermoplastic by way of side-feed equipment and then the melamine resin ether can be fed into the thermoplastic melt comprising pre-impregnated wood by way of side-feed equipment, and the melt mixture is devolatilized after homogenization, and
   in the second extruder segment, at melt temperatures of from 100 to 150° C., from 0.1 to 2% by weight, based on the melamine resin ether, of hardeners, from 0.1 to 2% by weight, based on the thermoplastics, of thermally decomposing free-radical generators, and, if appropriate, from 0.2 to 4% by weight, based on the entirety of thermoplastic and melamine resin ether, of blowing agent are fed into the melt mixture and are homogenized in the melt mixture, where a form in which blowing agents, hardeners, and/or thermally decomposing free-radical generators can be used is that of a from 60 to 90% by weight of thermoplastic-containing masterbatch,
and where from 3 to 10% by weight of flame retardants, from 0.1 to 2% by weight of pigments, from 0.1 to 5% by weight of stabilizers, and/or from 0.1 to 5% by weight of auxiliaries, based in each case on the entirety of melamine resin ether, wood, and thermoplastic, can be fed into the extruder in the first and/or second extruder segment, and in the third stage of the process, the melt mixture comprising wood in the form of wood flour, wood particles, wood granules, wood fibers, and/or wood shavings
   is either heated in a third extruder segment at temperatures of from 150 to 240° C., discharged through a die with crosslinking and, if appropriate, foaming, and drawn off as semifinished product,
   or is discharged from the extruder and pelletized, and the pellets of molding composition are processed in a third stage of the process at temperatures of from 150 to 240° C. in presses, in extruders, or in injection-molding machines, with hardening and, if appropriate, foaming, to give semifinished products or molded materials.

Examples of suitable mixers which can be used in the pre-impregnating process for the impregnation of wood in the form of wood flour, wood particles, wood granules, wood fibers, and/or wood shavings, with aqueous solutions or dispersions of melamine resin condensates are paddle mixers, plowshare mixers, centrifugal mixers, and also mixing equipment with a mixing screw.

A third process for production of inventive composite materials consists in producing these by a sintering process, where in a

a) first stage of the process, mixtures composed of wood and of plastics which are composed of melamine resin ethers or which are composed of mixtures composed of melamine resin ethers and of thermoplastics, or are composed of thermoplastics, are sintered in high-speed mixers, the sinter mixture is cooled, and, after cooling, hardeners, thermally decomposing free-radical generators, and/or blowing agents, flame retardants, pigments, stabilizers, and/or auxiliaries are applied to the sinter mixture in the drum mixer, and in a

b) second stage of the process, the sinter mixture comprising wood, and comprising melamine resin ethers and, if appropriate, comprising thermoplastics is processed in presses, in extruders, or in injection-molding machines, with crosslinking and, if appropriate, foaming, to give semifinished products or molded materials.

By way of example, in the first stage of the process mixtures composed of wood in the form of wood flour, wood particles, wood granules, wood fibers, and/or wood shavings whose residual moisture level is up to 10% by weight, where the wood can have been impregnated with from 2 to 15% by weight, based on the dry wood solids, of melamine resins, and composed of plastics which are composed of melamine resin ethers whose number-average molecular weights are from 1500 to 200 000 and whose molar melamine/formaldehyde ratio is from 1:1.5 to 1:4, or are composed of mixtures composed of melamine resin ethers and of thermoplastics, or are composed of thermoplastics, are sintered in high-speed mixers with residence times of from 3 to 30 min and final temperatures of from 90 to 180° C., the sinter mixture is cooled to temperatures of from 50 to 120° C., and, after cooling, from 0.1 to 3% by weight, based on the melamine resin ethers, of hardeners, from 0.1 to 2% by weight, based on the thermoplastics, of thermally decomposing free-radical generators, and, if appropriate, from 0.2 to 4% by weight, based on the entirety of thermoplastic and melamine resin ether, of blowing agents, and from 3 to 10% by weight of flame retardants, based in each case on the entirety of melamine resin ether, wood, and thermoplastic, from 0.1 to 2% by weight of pigments, from 0.1 to 5% by weight of stabilizers, and/or from 0.1 to 5% by weight of auxiliaries are applied to the sinter mixture in the drum mixer, and in the second stage of the process the sinter mixture comprising wood in the form of wood flour, wood particles, wood granules, wood fibers, or wood shavings, and comprising melamine resin ether and, if appropriate, comprising thermoplastics is processed at temperatures of from 150 to 240° C. in presses, in extruders, or in injection-molding machines, with crosslinking and, if appropriate, foaming to give semifinished products or molded materials.

In the sintering process, heat is introduced in the internal mixer both via frictional heating and via jacket heating.

Wood can be used in the variants of the process in the form of wood flour, wood particles, wood granules, wood fibers, and/or wood shavings whose residual moisture level is up to 10% by weight. The residual moisture level indicates the amount of water given off during a period of 24 h during drying of the wood at 103° C.

In the inventive variants of the process, preference is given to use of wood in the form of wood flour, wood particles, wood granules, wood fibers, or wood shavings where the wood comprises from 3 to 10% by weight of sodium borate or sodium borate/boric acid mixtures in a ratio by weight of from 1:9 to 9:1.

The content of sodium borate or of sodium borate/boric acid mixtures in the wood can be achieved via impregnation from aqueous solution and subsequent drying, or by applying powder.

The melamine resin ethers used in the variants of the process for production of composite materials are preferably etherified melamine resin condensates which are free from hydroxymethyleneamino groups bonded to the triazine rings of the melamine resin condensate, and from —NH—CH₂—O—CH₂—NH— groups linking triazine rings, and in which the etherification of the hydroxymethylamino groups has been accomplished via C₁-C₁₈ alcohols and/or via diols of the type HO—R—OH with molecular weights of from 62 to 20 000. The melamine resin ethers used to prepare the composite materials are preferably prepared by etherifying melamine resin precondensates with C₁-C₄ alcohols, where appropriate with subsequent partial transetherification with C₄-C₁₈ alcohols, C₂-C₁₈ diols, polyhydric alcohols of the glycerol or pentaerythritol type, C₅-C₁₈ amino alcohols, polyalkylene glycols, polyesters containing hydroxy end groups, siloxane polyesters, siloxane polyethers, melamine-alkylene oxide adducts and/or binucleic phenol-alkylene oxide adducts, and subsequent thermal condensation of the melamine resin ethers in the melt in a continuous kneading apparatus at temperatures from 140 to 220° C.

Hardeners used for the melamine resin ethers, in the case of the variants of the process for production of composite materials, can be weak inorganic acids such as boric acid and/or organic acids or acidifiers.

As hardeners for the melamine resin ethers in the case of the processes for production of composite materials it is preferred to use aliphatic C₄-C₁₈ carboxylic acids, aromatic C₇-C₁₈ carboxylic acids, acidifiers of the type represented by blocked sulfonic acids, alkali metal salts, or ammonium salts of phosphoric acid, C₁-C₁₂-alkyl esters or C₂-C₈-hydroxyalkyl esters of C₇-C₁₄-aromatic carboxylic acids or of inorganic acids, salts of melamine or of guanamines with C₁-C₁₈-aliphatic carboxylic acids, or comprises anhydrides, half-esters or half-amides of C₄-C₂₀ dicarboxylic acids, or comprises half-esters or half-amides of copolymers composed of ethylenically unsaturated C₄-C₂₀ dicarboxylic anhydrides and of ethylenically unsaturated monomers of the type represented by C₂-C₂₀ olefins and/or C₈-C₂₀ vinylaromatics, and/or salts of C₁-C₁₂-alkylamines and, respectively, alkanolamines with C₁-C₁₈-aliphatic, C₇-C₁₄-aromatic, or alkylaromatic carboxylic acids, or with inorganic acids of the type represented by hydrochloric acid, sulfuric acid, or phosphoric acid.

Examples of aliphatic C₄-C₁₈ carboxylic acids as hardeners for the melamine resin ethers are butyric acid, caproic acid, palmitic acid, stearic acid, and oleic acid.

Examples of aromatic C₇-C₁₈ carboxylic acids as hardeners for the melamine resin ethers are benzoic acid, phthalic acid, or naphthalenedicarboxylic acid.

Examples of block sulfonic acids as hardeners for the melamine resin ethers are benzil monoxime tosylate, benzil monoxime p-dodecylbenzenesulfonate, 4-chloro-α-trifluoroacetophenone oxime benzenesulfonate, and 2-pentafluorophenylsulfonyloxyimino-4-phenylbut-3-enenitrile.

Examples of alkali metal salts or ammonium salts of phosphoric acid as hardeners for the melamine resin ethers are ammonium hydrogenphosphate, sodium polyphosphate, and potassium hydrogenphosphate.

Examples of C₁-C₁₂-alkyl esters and C₂-C₈ hydroxyalkyl esters of C₇-C₁₄-aromatic carboxylic acids as hardeners for the melamine resin ethers are dibutyl phthalate, phthalic acid diglycol esters and/or trimellitic acid glycol esters.

Examples of salts of melamine or guanamines with C₁-C₁₈-aliphatic carboxylic acids as hardeners for the melamine resin ethers are melamine formate, melamine citrate, melamine maleate, melamine fumarate, and/or acetoguanamine butyrate.

Examples of anhydrides, half-esters or half-amides of C₄-C₂₀ dicarboxylic acids as hardeners for the melamine resin ethers are maleic anhydride, succinic anhydride, phthalic anhydride, mono-C₁-C₁₈-alkyl maleates, maleic acid monoamide or maleic acid mono-C₁-C₁₈-alkyl amides.

Examples of mono-C₁-C₁₈-alkyl maleates as hardeners for the melamine resin ethers are monobutyl maleate, monoethylhexyl maleate or monostearyl maleate.

Examples of maleic acid mono-C₁-C₁₈-alkyl amides as hardeners for the melamine resin ethers are maleic acid monoethyl amide, maleic acid monooctyl amide or maleic acid monostearyl amide.

Examples of half-esters or half-amides of copolymers of ethylenically unsaturated C₄-C₂₀ dicarboxylic anhydrides and ethylenically unsaturated monomers of the type represented by C₂-C₂₀ olefins and/or C₈-C₂₀ vinylaromatics as hardeners for the melamine resin ethers are half-esters or half-amides of copolymers of maleic anhydride and C₃-C₈ α-olefins of the type represented by isobutene, diisobutene and/or 4-methylpentene and/or styrene with a molar ratio of maleic anhydride/C₃-C₈ α-olefin or styrene, or corresponding monomer mixtures of from 1:1 to 1:5.

Examples of salts of C₁-C₁₂-alkylamines and, respectively, alkanolamines with C₁-C₈ aliphatic, C₇-C₁₂ aromatic or alkylaromatic carboxylic acids, or with inorganic acids of the type represented by hydrochloric acid, sulfuric acid, or phosphoric acid, as hardeners for the melamine resin ethers are ethanolammonium chloride, triethylammonium maleate, diethanolammonium phosphate, and/or isopropylammonium p-toluenesulfonate.

In the variants of the process for production of composite materials it is preferred to use, as thermoplastics, ethylene-vinyl acetate copolymers, partly hydrolyzed ethylene-vinyl acetate copolymers, thermoplastic polyurethanes, high-molecular-weight aliphatic and/or aromatic-aliphatic polyethers and/or aliphatic and/or aromatic-aliphatic polyesters, preferably polycaprolactones and/or unsaturated polyesters.

Suitable ethylene-vinyl acetate copolymers for the production of composite materials are those possessing a vinyl acetate content of from 4 to 50% by weight and melt indices in the range from 0.5 to 400 g/10 min at 190° C./2.16 kp.

Suitable partly hydrolyzed ethylene-vinyl acetate copolymers for the production of composite materials are those possessing an initial vinyl acetate content of from 4 to 50% by weight and melt indices in the range from 0.5 to 400 g/10 min at 190° C./2.16 kp, and in which from 5 to 50 mol % of the vinyl acetate groups are hydrolyzed to vinyl alcohol groups.

For improved metering it is possible to use ethylene copolymers with a high vinyl acetate content in the form of granules powdered with talc.

Examples of thermoplastic polyurethanes which can be used in the variants of the process for production of composite materials are polyurethanes based on tolylene diisocyanate, diphenylmethane diisocyanate, butane diisocyanate, and/or hexane diisocyanate as diisocyanate components and on butanediol, hexanediol, and/or polyalkylene glycols as diol components, with molecular weights of from 2000 to 30 000.

Examples of polyethers which can be used in the variants of the process for production of composite materials are preferably polyalkylene glycols having molecular weights of from 20 000 to 70 000.

Examples of suitable polycaprolactones which can be used in the variants of the process for production of composite materials are polycaprolactones having densities of from 1.05 to 1.15 g/cm³ at 60° C., viscosities in the range from 500 to 5000 Pas at 100° C., and melt indices in the range from 2 to 80 g/10 min at 160° C./2.16 kp. The polycaprolactones may likewise be ethylene oxide adducts with polycaprolactone.

As thermally decomposing free-radical generators for crosslinking the thermoplastic component use is made, in the process for production of composite materials, of, preferably, free-radical generators whose thermal decomposition is concluded at below 210° C., of the type represented by acyl peroxides, alkyl peroxides, hydroperoxides, peroxycarbonates, and/or peresters.

Examples of suitable acyl peroxides which can be used as thermally decomposing free-radical generators in the production of composite materials are benzoyl peroxide, 4-chlorobenzoyl peroxide, 3-methoxybenzoyl peroxide, and methylbenzoyl peroxide.

Examples of suitable alkyl peroxides which can be used as thermally decomposing free-radical generators in the production of composite materials are allyl tert-butyl peroxide, 1,1-bis(tert-butylperoxy)-3,3,5-trimethyl-cyclohexane, di(tert-butylperoxyisopropyl)benzene, di-ethylaminomethyl tert-butyl peroxide, tert-butyl cumyl peroxide, and tert-butyl peroxide.

Examples of suitable peresters and peroxycarbonates which can be used as thermally decomposing free-radical generators for the production of composite materials are butyl peracetate, cumyl peracetate, cumyl perproprionate, cyclohexyl peracetate, di-tert-butyl peradipate, tert-butyl cyclobutanepercarboxylate, tert-butyl 2-propylperpentene-2-oate, tert-butyl 1-methyl-cypropylpercarboxylate, and tert-butyl perpropionate.

Where ethylene-vinyl acetate copolymers and/or partly hydrolyzed ethylene-vinyl acetate copolymers are used as thermoplastics in the processes for production of composite materials, the requisite crosslinking may likewise be achieved by adding alkali metal alkoxylates such as sodium methoxide, potassium methoxide, or sodium tert-butoxide.

In case of the variants of the process for production of composite materials it is preferred as blowing agents to use gas-evolving blowing agents, especially sodium hydrogencarbonate, azodicarbonamide, citric acid/bicarbonate blowing systems, and/or acid hydrazides such as cyanuric hydrazide, toluenesulfonic hydrazide or oxobissulfonic hydrazide.

Where the production of foamed semifinished products or molded materials takes place, in the case of the extruder process or the preimpregnation process, in an immediately downstream process stage, then foaming may likewise take place with metered introduction of C₃-C₆ hydrocarbons such as isobutane or pentane or of inert gases as physical blowing agents. These blowing agents can likewise be used when the semifinished products or molded materials are produced starting from the molding compound by extrusion.

The composite materials of the invention are used preferably in the construction industry, in particular for the production of windows, of doors, of cladding elements, and of roof elements in the outdoor sector, or else in the sports and leisure sector for garden furniture and outdoor seating, and for construction of playgrounds.

The invention is illustrated by examples which follow:

The rheological characterization of the processing behavior associated with the production of the composite material took place in the examples using a high-pressure capillary rheometer; the data were evaluated by temperature-invariant representation of the viscosity curves in accordance with the Carreau approach:

Viscosity Measurement

The viscosity measurements were conducted on a high-pressure capillary rheometer, model Rheograph 2002, manufacturer Göttfert Werkstoff-Prüfmaschinen GmbH, Buchen, Germany, in accordance with DIN 53014/ISO 11443.

The measurements were carried out using a slot die with a slot height H of 2.5 mm and a slot breadth B of 10 mm. The diameter of the supply cylinder was 15 mm.

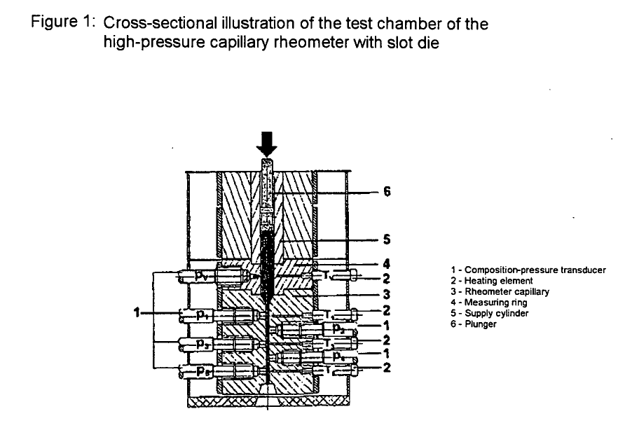

A cross-sectional representation of the test chamber of the high-pressure capillary rheometer, with the slot die used, is depicted in FIG. 1.

The pressure was measured at 4 points along the flow channel (p₁/p₂/p₄/p₅=27.5/42.5/72.5/87.5 mm from the start of the slot die).

The temperature was measured at 3 points along the flow channel, at a distance of 1 mm from the surface of the flow channel (T₁, T₃ and T₅).

Evaluation

The rheological measurements produce the pressures P₁ to P₅ of the respective pressure transducers for a given punch speed (see FIG. 1). The first calculation, from the die geometry and the difference in pressure of two pressure transducers, is of the wall shear stress τ_{w}. The pressure difference Δp is formed from the pressures P₂ and P₄, in order to rule out any disruptive effects from the die entrance and the die end.
Δp=P₂−P₄ (1)

The wall shear stress, taking into account the side wall areas, produces, in accordance with equation (2)

$${τ}_{w} = \frac{Δ p \cdot ( B \cdot H )}{2 \cdot L \cdot ( B + H )} \qquad ( 2 )$$

with B—slot breadth, H—slot height, L—measuring slot length.

The volume throughput V is calculated from the punch speed v_{plunger}.

$$\dot{V} = {v}_{plunger} \cdot \frac{{D}^{2} π}{4} \qquad ( 3 )$$

with D—punch diameter.

In the case of simple wall sticking, taking into account the ultimate breadth of the slot channel, the corrected volume throughput is produced as

$${\dot{V}}_{H , corr} = {\dot{V}}_{H} \cdot \frac{1}{{F}_{p}} \qquad ( 4 )$$

Since the Fₚ factor adopts values <1, taking into account the ultimate breadth of the slot channel entails an increase in the shear rate. The corrected volume throughput is used to determine the viscosity. The apparent shear rate \dot{γ}ₛ in the rectangular slot is produced in accordance with equation (5)

$${\dot{γ}}_{s} = \frac{6 \cdot {\dot{V}}_{H , corr}}{B \cdot {H}^{2}} \qquad ( 5 )$$

With the aid of the Weiβenberg-Rabinowitsch correction, the true shear rate \dot{γ}_{w} is obtained.

$${\dot{γ}}_{w} = \frac{{\dot{γ}}_{s}}{4} \cdot ( 3 + s ) \qquad ( 6 )$$

where for s it is the case that:

$$s = \frac{ⅆ ( log {\dot{γ}}_{s} )}{ⅆ ( log {τ}_{w} )} \qquad ( 7 )$$

The true viscosity η is given by

$$η = \frac{{τ}_{w}}{{\dot{γ}}_{w}} \qquad ( 8 )$$

The viscosity at arbitrary temperature and arbitrary shear rate is found, using the Ostwald-deWaele power approach, by

$$η ( T ) = {( \frac{{a}_{T}}{ϕ} )}^{\frac{1}{m}} {\dot{γ}}^{\frac{1}{m} - 1} \qquad ( 9 )$$

with: Φ—fluidity, m—flow index, with m<1, a_{T}—temperature shift factor,
and, using the Carreau approach, is found as

$$η ( T ) = \frac{A \cdot {a}_{T}}{{( 1 + B \cdot \dot{γ} \cdot {a}_{T} )}^{C}} \qquad ( 10 )$$

with: A,B,C—Carreau constants, A denoting the zero viscosity.

The temperature shift factor a_{T} according to Arrhenius is used for partly crystalline thermoplastics and is defined as

$${a}_{T} = exp \{ \frac{Δ {U}_{τ}}{R} ( \frac{1}{T} - \frac{1}{{T}_{0}} ) \} \qquad ( 11 )$$

with: ΔU—activation energy at constant wall shear stress in kJ/mol,
   R—universal gas constant (=8.314 kJ/mol·K),
   T₀=reference temperature in K.

### EXAMPLE 1

### 1.1 Production of Thermoplastically Processable Melamine Resin Ethers

In a 30 l stirred autoclave a melamine dispersion is prepared by introducing 4.0 kg of melamine into 14.2 kg of methanol at 95° C., and, after a pH of 5.9 has been set in the stirred autoclave using 10% HCl, 7.7 kg of a 37% formaldehyde solution, preheated to 60° C., is metered in under pressure, and the reaction mixture is reacted at a temperature of 95° C. for a time of 20 minutes.

After cooling to 30° C., 10% strength sodium hydroxide solution is added to set a pH of 9, and the etherified melamine resin condensate, in solution in the water/methanol mixture, is admixed with 2.5 kg of butanol and then transferred to a first vacuum evaporator, in which the solution of the etherified melamine resin condensate is concentrated at 82° C. to form a highly concentrated melamine resin solution possessing a solids fraction of 76% by weight and a butanol content of 8% by weight.

Subsequently the highly concentrated solution of the etherified melamine resin is transferred to a second vacuum evaporator, where it is concentrated at 90° C. to form a syrupy melt possessing a solids fraction of 96% by weight and a butanol content of 2% by weight.

In a mixing section the syrupy melt is mixed with 2.27 kg of polyethylene glycol (molar weight 1000), the mixture is metered into the intake hopper of a GL 27 D44 laboratory extruder (temperature profile 150/200/200/230/230/230/230/230/230/130/130° C., extruder speed 150 min⁻¹) with vacuum devolatilization zones after the intake zone and also after the reaction zone, before the product discharge point; the reaction mixture is devolatilized at 800 mbar, and after a residence time in the reaction zone of 3.1 min the volatiles are removed at 900 mbar, and the emerging extrudate is chopped in a granulator. To improve meterability the granules are powdered with 0.3% by weight of talc.

The etherified melamine resin condensate possesses a weight-average molecular weight (GPC) of 24 000 and a butoxy groups fraction of 0.3% by weight.

Hydroxymethyleneamino groups bonded to the triazine rings of the melamine resin condensate, and —NH—CH₂—O—CH₂—NH— groups linking triazine rings, are not detectable in the IR spectrum.

In a similar way, in accordance with the above working instructions the thermoplastic melamine resin ethers listed in table 2 are synthesized. Table 2 shows an overview of batch sizes and weight-average molecular weights of the melamine resin ethers obtained.

### 1.2 Production of the Composite Material

A Werner & Pfleiderer ZSK 30 extruder, LD=48, with side stream feed for solid and liquid substances, vacuum devolatilization and a sheet mold (4.0×100.0 mm) is fed via its intake hopper with at 1.86 kg/h the etherified melamine resin condensate 1 according to 1.1, at 0.8 kg/h an ethylene-vinyl acetate copolymer (vinyl acetate content 28% by weight, melt index 25 g/10 min at 190° C./2.16 kg), containing 0.5% by weight of di(tert-butylperoxyisopropyl)benzene as crosslinker, and at 0.54 kg/h with borax, and the feed components are melted at 130° C. and homogenized. Wood in the form of wood fibers (average length 1 mm, average diameter 0.2 mm, residual moisture level 1% by weight), at 7.5 kg/h, and polyethylene glycol (molecular weight 35 000), at 0.54 kg/h, are metered into the melt via a side stream feed, and the melt containing wood fibers and polyethylene glycol is homogenized at a melt temperature of 130° C. and devolatilized at 880 mbar. Following devolatilization, the melt is discharged through a sheet mold at 180° C., and drawn off as a crosslinked sheet.

Test specimens punched from the composite wood fiber sheet possess a density of 1.22 g/cm³ and a tensile elasticity modulus of 3.1 GPa.

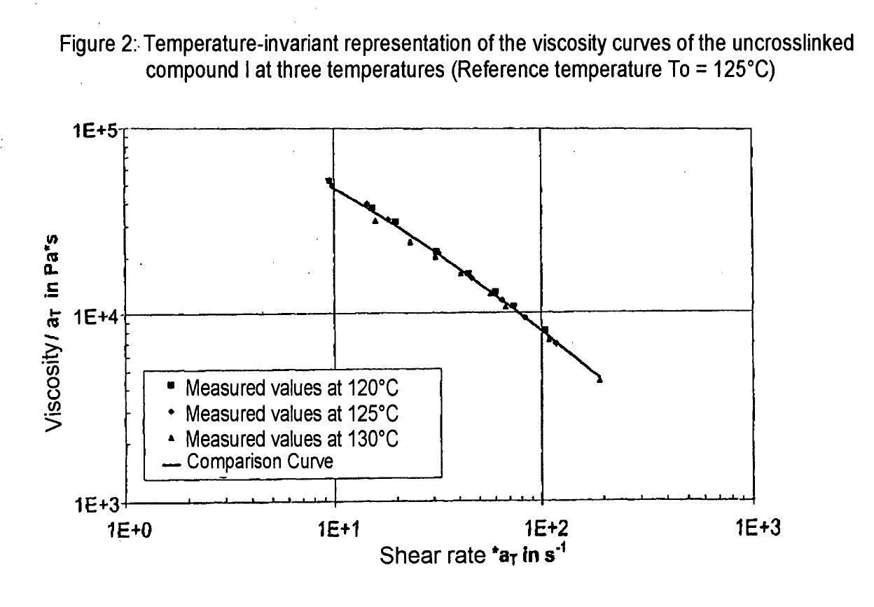

The uncrosslinked wood/melamine resin/additive compound, homogenized at 130° C., can, by the viscosity values shown in tab. 3 and by the temperature-invariant representation of the viscosity curves that is set out in FIG. 2 (Carreau approach, A=1.38*10⁵ Pa*s; B=2.19*10⁻¹ s; C=9.1*10⁻¹; Tₒ=125° C.; ΔUτ=60.8 KJ/mol), be characterized rheologically.

In a similar way, in accordance with the above working instructions, the composite materials set out in table 4 were produced from the melamine resin ethers described under 1.1.

### EXAMPLE 2

### 2.1 Production of Thermoplastically. Processable Plastic

In a 30 l stirred autoclave a melamine dispersion is prepared by introducing 4.0 kg of melamine into 14.2 kg of methanol at 95° C., and, after a pH of 5.9 has been set in the stirred autoclave using p-toluenesulfonic acid, 7.7 kg of a 37% formaldehyde solution, preheated to 60° C., is metered in under pressure, and the reaction mixture is reacted at a temperature of 95° C. for a time of 20 min.

After cooling to 30° C., a pH of 9 is set by addition of 10% strength sodium hydroxide solution. Subsequently 1.2 kg of polyethylene glycol (molecular weight 1000) are added to the etherified melamine resin condensate in solution in the water/methanol mixture. After the diol has been dissolved, the aqueous-methanolic solution is transferred to a first vacuum evaporator, in which the solution of the etherified melamine resin condensate is concentrated at 82° C. to form a highly concentrated melamine resin solution possessing a solids fraction of 78% by weight.

Subsequently the highly concentrated solution of the etherified melamine resin is transferred to a second vacuum evaporator, where it is concentrated at 90° C. to form a syrupy melt possessing a solids fraction of 97% by weight.

The syrupy melt of the melamine resin mixed with polyethylene glycol is fed at 11 kg/h into the intake hopper of a GL 27 D44 laboratory extruder (temperature profile 195/195/195/195/250/250/250/250/135/130/130° C., extruder speed 250 min⁻¹) with vacuum devolatilization zones after the intake zone and after the reaction zone, and is subjected to devolatilization at 800 mbar. In zone 9 4.7 kg/h of a masterbatch based on an ethylene-vinyl acetate copolymer (vinyl acetate content 28% by weight, melt index 25 g/10 min at 190° C./2.16 kg), containing as crosslinker 0.5% by weight of di(tert-butylperoxyisopropyl)benzene and 5% by weight of sodium 3-(2H-benzotriazol-2-yl)-5-sec-butyl-4-hydroxybenzenesulfate, is metered into the melt of the melamine resin ether via side stream feed, and the resultant melt of the melamine resin ether/ethylene-vinyl acetate copolymer blend is homogenized at a melt temperature of 130° C., and the emerging extrudate is chopped in a granulator.

The etherified melamine resin condensate possesses a weight-average molecular weight (GPC) of 22 000. Hydroxymethyleneamino groups bonded to the triazine rings of the melamine resin condensate, and —NH—CH₂—O—CH₂—NH— groups linking triazine rings, are not detectable in the IR spectrum.

In a similar way, in accordance with the above working instructions, the thermoplastic melamine resin ethers with ethylene-vinyl acetate copolymers, or partly hydrolyzed ethylene-vinyl acetate copolymers listed in table 5, were homogenized to form thermoplastically processable plastics blends.

### 2.2 Production of the Composite Material

A Werner & Pfleiderer ZSK 30 extruder, LD=48, with side stream feed for solid and liquid substances, vacuum devolatilization, and 4.0×100.0 sheet mold is fed via the intake hopper at 3.9 kg/h with the blend of the etherified melamine resin condensate (blend A according to 2.1), and this feed is melted at 130° C. Wood in the form of wood fibers (average length 1.5 mm, average diameter 0.2 mm, residual moisture level 0.5% by weight), at 11 kg/h, and, as additives, 0.8 kg/h of polyethylene glycol (molecular weight 35 000) and 0.8 kg/h of disodium tetraborate, are fed via a side stream feed, and devolatilization is carried out at 880 mbar. Following devolatilization, the melt is homogenized at 130° C., discharged through a 4×100 mm sheet mold at 180° C., and drawn off as a crosslinked sheet.

Test specimens punched from the composite wood fiber sheet possess a density of 1.22 g/cm³ and a tensile elasticity modulus of 3.2 GPa.

In a similar way, in accordance with the above working instructions, the composite materials set out in table 6 were produced from the melamine resin ether blends.

### EXAMPLE 3

### 3.1 Preparation of the Melamine Resin Impregnating Solution

In a 30 l stirred autoclave a melamine resin dispersion is prepared by introducing 1.0 kg of melamine into 13.9 kg of methanol at 95° C., and after a pH of 6.0 has been set in the stirred autoclave, using 10% HCl, 2.25 kg of a 37% formaldehyde solution preheated to 60° C. is metered in under pressure, and the reaction mixture is reacted at a temperature of 90° C. for a time of 15 minutes.

After cooling to 65° C., a pH of 9 is set by addition of 10% NaOH. The melamine resin condensate in solution in the water/methanol mixture, and whose principal component is 2,4-dimethoxymethyl-6-hydroxymethylmelamine, is transferred to a vacuum evaporator, where it is concentrated to a solids content of approximately 50%.

### 3.2 Production of the Composite Material

A screw mixer (length 2200 mm, screw diameter 35 mm) with feed port for liquid substances at L/D=6 and devolatilization ports at L/D=40 and 50, the temperature gradient from the intake to the devolatilization port being 80 to 102° C., is fed with 4.9 kg/h of spruce shavings (average length 2.8 mm, average diameter 0.9 mm, residual moisture levels 0.5% by weight). A melamine resin impregnating solution in accordance with 3.1 is sprayed at 0.9 kg/h onto the shavings, via the feed port, and the shavings impregnated with the melamine resin solution are devolatilized, dried, and then discharged.

The intake hopper of a Werner & Pfleiderer ZSK 30 twin-screw extruder, L/D 48, is fed at 4.5 kg/h with a 7:3 mixture of the thermoplastically processible melamine resin ether 1 according to 1.1 and granules based on ethylene-vinyl acetate copolymer (vinyl acetate content 28% by weight, melt index 150 g/10 min at 190° C./2.16 kg), and this feed is melted at a melt temperature of 130° C. Fed into the melt via a side stream feed are, at 10 kg/h, the melamine resin solution-impregnated spruce shavings and, at 0.5 kg/h, polyethylene glycol (molar weight 35 000), these components are distributed homogeneously in the melt at 130° C., and the mixture is subjected to vacuum devolatilization at 850 mbar. Following devolatilization, at a melt temperature of 125° C., 0.8 kg/h of ammonium polyphosphate, 1 kg/h of an EVA masterbatch containing 5% by weight phthalic anhydride, 20% by weight azodicarbonamide and 2.5% by weight di-tert-butyl peroxide are fed into the melt, and the melt, which contains wood shavings, is discharged and granulated. The molding compound containing wood shavings is melted at 140° C. in an extruder with a U-shaped profile mold, discharged at 180° C. through the U-shaped profile mold, and drawn off as a crosslinked profile.

Test specimens punched from the composite wood fiber sheet possess a density of 0.95 g/cm³ and a tensile elasticity modulus of 2.9 GPa.

### EXAMPLE 4

A Leistritz Micro 27 extruder, LD=44, with a side stream feed for solid and liquid substances, vacuum devolatilization and a sheet mold (4.0×100.0 mm), is fed via its intake hopper with 3.0 kg/h of an ethylene-vinyl acetate copolymer (vinyl acetate content 20% by weight, melt index 25 g/10 min at 190° C./2.16 kp) and the feed is melted at 130° C. Introduced into the melt via a side stream feed are, at 7.5 kg/h, wood in the form of wood fibers (average length 1 mm, average diameter 0.2 mm, residual moisture level 8% by weight) and, subsequently, at 0.9 kg/h, the etherified melamine resin 7 (cf. 1.1), and the ethylene-vinyl acetate copolymer/melamine resin ether melt, containing wood fibers, is homogenized at a melt temperature of 130° C. and devolatilized at 850 mbar.

Following devolatilization, the melt of ethylene-vinyl acetate copolymer and melamine resin ether, containing wood fibers, is admixed at a melt temperature of 150° C. with 0.84 kg/h of ammonium polyphosphate and with 0.84 kg/h of a polyethylene wax masterbatch containing 5% by weight sodium methoxide, 20% by weight 2-(2-hydroxy-3-tert-butyl-5-methylphenyl)benzotriazole, 15% by weight monostearyl maleate, and 10% by weight zinc stearate, and the composition is homogenized at a melt temperature of 175° C., discharged through a 4×100 mm sheet mold, and drawn off as a crosslinked sheet.

Test specimens punched from the composite wood fiber sheet possess a density of 1.2 g/cm³ and a tensile elasticity modulus of 5.0 GPa.

Test specimens produced from the sheet gave a fire performance to DIN 4102 of B1 (low flammability).

### EXAMPLE 5

In a high-speed mixer (internal volume 10 l, jacket heating 55° C.) 1.0 kg of oak particles (residual moisture level 2% by weight, average diameter 2.5 mm) and 0.3 kg of granules based on an ethylene-vinyl acetate copolymer (vinyl acetate content 28% by weight, melt index 150 g/10 min at 190° C./2.16 kg) are introduced and mixed at 3500 min⁻¹.

When the melt temperature has reached 135° C., the speed is lowered to 1200 min⁻¹, and, after cooling to a melt temperature of 110° C., the mixture is supplied with 0.4 kg of the thermoplastic melamine resin 5 (cf. 1.1). After a further 5 minutes, 40 g of dihydroxybenzophenone, 130 g of zinc borate, 30 g of magnesium stearate, 5 g of phthalic anhydride, 5 g of tert-butyl perbenzoate and 25 g of cyanuric trihydrazide are applied by drum at 85° C. to the fluidized sintering mixture, and the sintering mixture is discharged.

The sintering mixture, which contains oak particles, is melted in a sheet mold with movable punch at 155° C./80 bar, and foaming is carried out after the pressure has been lowered to 2 bar. The incipiently foamed crosslinked composite sheet possesses a density of 0.82 g/cm³. Test specimens produced from the sheet showed a fire behavior to DIN 4102 of B1 (low flammability).

### EXAMPLE 6

In a high-speed mixer (internal volume 10 l, jacket heating 75° C.) 0.9 kg of spruce chips (average length 2.8 mm, average diameter 0.9 mm, residual moisture level 5% by weight), 0.4 kg of spruce fibers (average length 0.4 mm, average diameter 0.15 mm, residual moisture level 4% by weight), 0.35 kg of granules based on an ethylene-vinyl acetate copolymer (vinyl acetate content 18% by weight, melt index 150 g/10 min at 190° C./2.16 kg) and 0.10 kg of polypropylene glycol (molecular weight 8000) are introduced and fluidized at 3500 min⁻¹.

When a melt temperature of 145° C. has been reached the speed is lowered to 1200 min⁻¹, and, after cooling to a melt temperature of 110° C., the fluidized sintering mixture is supplied with 0.3 kg of the thermoplastic melamine resin 1 in accordance with 1.1. After a further 4 minutes, 45 g of bis[2,2,6,6-tetra methyl-1-(octyloxy)-4-piperidinyl]sebacate, 170 g of melamine cyanurate, 30 g of zinc stearate, 5 g of maleic anhydride and 5 g of dicumyl peroxide are applied by drum to the fluidized sintering mixture, and the sintering mixture is discharged.

The sintering mixture, which contains spruce shavings and spruce fibers, is processed to crosslinked standard test rods in a Ferromatic Millacron FM 60 injection molding machine (triple-zone screw, L=22 D) at a melt temperature of 185° C. and a mold temperature of 50° C. The standard test rods possess a density of 0.98 g/cm³ and a tensile elasticity modulus of 3.5 GPa, and give a fire behavior to DIN 4102 of B1 (low flammability).

### EXAMPLE 7

In a high-speed mixer (internal volume 10 l, jacket heating 100° C.) 1.0 kg of spruce shavings (average length 2.8 mm, average diameter 0.9 mm, residual moisture level 5% by weight), 0.5 kg of spruce fibers (average length 0.4 mm, average diameter 0.15 mm, residual moisture level 4% by weight), 0.25 kg of granules based on a partly hydrolyzed ethylene-vinyl acetate copolymer (initial vinyl acetate content 22% by weight, degree of hydrolysis 30 mol %, melt index 60 g/10 min at 190° C./2.16 kg) and 0.2 kg of a thermoplastic polyurethane based on hexamethylene diisocyanate and dodecanediol are introduced and fluidized at 4000 min⁻¹.

When a melt temperature of 180° C. has been reached the speed is lowered to 1200 min⁻¹, and, after cooling to a melt temperature of 120° C., the fluidized sintering mixture is supplied with 250 g of the melamine resin 4 in accordance with 1.1.

After a further 4 minutes, 45 g of bis[2,2,6,6-tetra-methyl-1-(octyloxy)-4-piperidinyl]sebacate, 200 g of disodium tetraborate, 30 g of zinc stearate, 5 g of phthalic anhydride and 5 g of di-tert-butyl peroxide are applied by drum to the fluidized sintering mixture, and the sintering mixture is discharged.

The sintering mixture, which contains spruce shavings and spruce fibers, is processed to crosslinked standard test rods in a Ferromatic Millacron FM 60 injection molding machine (triple-zone screw, L=22 D) at a melt temperature of 200° C. and a mold temperature of 60° C. The standard test rods possess a density of 0.90 g/cm³ and a tensile elasticity modulus of 2.8 GPa, and give a fire behavior to DIN 4102 of B1 (low flammability).

TABLE 1
Flow correction factor - F_{ρ} for different
ratios of die breadths to die heights

| B in mm | H in mm | F_{ρ} |
|---|---|---|
| 10 | 1.0 | 0.93697 |
| 10 | 1.5 | 0.90546 |
| 10 | 2.0 | 0.87395 |
| 10 | 2.5 | 0.84243 |

TABLE 2
Batch size (in kg) and temperature profile (in ° C.) for preparing thermoplastic melamine
resins, and the weight-average molecular weights (GPC) of the products obtained

| | | Formaldehyde | | | | Weight-average molecular |
|---|---|---|---|---|---|---|
| Resin | Melamine | (37%) | Butanol | Diol | Temperature profile | weight |
| 1 | 4.0 | 7.7 | 2.5 | 2.27 (PEG 1000) | 150/200/200/230/230/ | 24 000 |
| | | | | | 230/230/230/230/130/130 | |
| 2 | 4.0 | 7.7 | — | 1.20 (PEG 1000) | 150/200/200/230/230/ | 20 000 |
| | | | | | 230/230/230/230/130/130 | |
| 3 | 4.0 | 5.9 | 1.5 | 1.75 (PEG 600) | 150/200/200/230/230/ | 22 000 |
| | | | | | 230/230/235/235/130/130 | |
| 4 | 4.0 | 7.7 | — | 1.25 (Simulsol BPLE)^{a} | 150/210/210/230/230/ | 25 000 |
| | | | | | 230/230/230/230/130/130 | |
| 5 | 4.0 | 6.0 | — | 1.5 (PPG 600) | 150/210/210/230/230/ | 20 000 |
| | | | | | 230/230/230/230/130/130 | |
| 6 | 4.0 | 7.7 | 2.0 | 2.0 (CAPA 2077A)^{b} | 150/200/210/230/230/ | 25 000 |
| | | | | | 230/230/230/230/130/130 | |
| 7 | 4.0 | 7.7 | — | 1.2 (PEG 1000) | 150/200/210/230/230/ | 21 000 |
| | | | | 1.0 (CAPA 4101)^{c} | 230/230/230/230/130/130 | |

^{a}Oligoethylene glycol ether of bisphenol A;
^{b}Polyester of ε-caprolactone with 1,6-hexanediol;
^{c}Polyester of ε-caprolactone with pentaerythritol

TABLE 3
Viscosity values of the uncrosslinked compound prepared
according to 1.2 (compound I, cf. tab. 4) at three melt
temperatures and with a die slot of 2.5 mm

| | | | | | |
|---|---|---|---|---|---|
| \dot{γ} | η | \dot{γ} | η | \dot{γ} | η |
| s⁻¹ | Pa*s | s⁻¹ | Pa*s | s⁻¹ | Pa*s |

| | | |
|---|---|---|
| 120° C. | 125° C. | 130° C. |

| | | | | | |
|---|---|---|---|---|---|
| 9.5 | 52812.9 | 9.8 | 49532.7 | 15.8 | 32062.8 |
| 15.2 | 38001.0 | 14.4 | 39749.6 | 23.2 | 24501.1 |
| 19.6 | 31808.8 | 18.2 | 32506.3 | 30.6 | 20273.0 |
| 30.9 | 21700.0 | 31.7 | 21318.8 | 40.9 | 16422.9 |
| 44.4 | 16406.7 | 46.2 | 15419.2 | 57.0 | 12735.2 |
| 59.7 | 13058.2 | 64.5 | 11695.2 | 67.3 | 10695.9 |
| 73.2 | 10850.8 | 83.3 | 9392.0 | 108.2 | 7214.7 |
| 103.4 | 8058.2 | 116.9 | 6855.6 | 189.3 | 4352.9 |

TABLE 4
Composition (in kg/h), homogenizing temperature (Tₕₒₘₒ in ° C.), take-off temperature
(T_{off} in ° C.), and mechanical properties of the composite materials produced
according to example 1.2 (density in g/cm³, tensile elasticity modulus in GPa),
and viscosity of uncrosslinked compounds (η_{Comp} at 130° C. in Pa*s).

| | | | | | | | Tensile | |
|---|---|---|---|---|---|---|---|---|
| | | | | | | | elasticity | |
| Compound | Resin (type) | Wood | EVA^{a} | Additive | Tₕₒₘₒ/T_{off} | Density | modulus | η_{Comp} |
| I | 1.86 (1) | 7.5 | 0.8 | 0.54 (PEG 35000) | 130/180 | 1.22 | 3.1 | 3.2*10⁴ (at 15.8 s⁻¹) |
| | | | | 0.54 (borax) | | | | |
| II | 2.45 (2) | 7.5 | 0 | 0.70 (PEG 35000) | 130/180 | 1.20 | 4.8 | 5.8*10⁴ (at 12.9 s⁻¹) |
| | | | | 0.60 (borax) | | | | |
| III | 3.9 (3) | 7.5 | 1.8 | 0.80 (PO/EO-block | 130/180 | 1.18 | 3.8 | 2.3*10⁴ (at 16.2 s⁻¹) |
| | | | | polymer with 50% EO, | | | | |
| | | | | molecular weight | | | | |
| | | | | approx. 6500) | | | | |
| | | | | 0.80 (borax) | | | | |
| IV | 5.0 (4) | 7.5 | 0 | 0.50 (PEG 35000) | 130/190 | 1.25 | 5.1 | 2.4*10⁴ (at 17.9 s⁻¹) |
| | | | | 0.10 (PPG 9000) | | | | |
| V | 4.5 (5) | 7.5 | 1.0 | 0.30 (PPG 9000) | 130/190 | 1.23 | 4.5 | 2.5*10⁴ (at 19.0 s⁻¹) |
| | | | | 0.40 (PEG 12000) | | | | |
| | | | | 0.50 (zinc borate) | | | | |
| IV | 3.0 (6) | 7.5 | 1.8 | — | 130/180 | 1.20 | 3.5 | 4.4*10⁴ (at 11.3 s⁻¹) |
| VII | 4.5 (7) | 7.5 | 1.5 | 0.5 (PEG 35000) | 130/180 | 1.20 | 4.6 | 2.3*10⁴ (at 20.0 s⁻¹) |

^{a}contains 0.5% di(tert-butylperoxyisopropyl)benzene

TABLE 5
Composition and homogenizing temperature (Tₕₒₘₒ in ° C.) of the thermoplastically processible
plastics produced according to example 2.1 (resin type and batch sizes cf. table 2)

| | | Resin | Thermoplastic/ | | |
|---|---|---|---|---|---|
| Blend | Resin | fraction | Masterbatch | Additives in the batch | Tₕₒₘₒ |
| A | 2 | 70 | EVA batch | 0.5% by weight di(tert-butylperoxyiso- | 130 |
| | | | (vinyl acetate content | propyl)benzene | |
| | | | 28% by weight, melt | 5.0% by weight sodium 3-(2H-benzotriazol-2- | |
| | | | index 25 g/10 min at | yl)-5-sec-butyl-4-hydroxybenzenesulfate | |
| | | | 190° C./2.16 kg) | | |
| B | 1 | 70 | EVA batch | 0.5% by weight di(tert-butylperoxyiso- | 130 |
| | | | (vinyl acetate content | propyl)benzene | |
| | | | 28% by weight, melt | 3.5% by weight sodium 3-(2H-benzotriazol-2- | |
| | | | index 25 g/10 min at | yl)-5-sec-butyl-4-hydroxybenzenesulfate | |
| | | | 190° C./2.16 kg) | 1.0% by weight N,N′-diformyl-N,N′-di(1-oxyl | |
| | | | | radical-2,2,6,6-tetramethyl-4-piperidinyl)- | |
| | | | | 1,6-hexanediamine | |
| C | 1 | 80 | EVA | — | 130 |
| | | | (vinyl acetate content | | |
| | | | 28% by weight, melt | | |
| | | | index 25 g/10 min at | | |
| | | | 190° C./2.16 kg) | | |
| D | 2 | 75 | EVA partly hydrolyzed | — | 140 |
| | | | (50%) (vinyl acetate content | | |
| | | | of the initial product: | | |
| | | | 20% by weight, melt | | |
| | | | index 150 g/10 min at | | |
| | | | 190° C./2.16 kg) | | |
| E | 6 | 80 | EVA batch | 0.5% by weight dicumyl peroxide | 130 |
| | | | (vinyl acetate content: | 4.0% by weight octyl 3-(2H-benzotriazol-2- | |
| | | | 28% by weight, melt | yl)-5-(1,1-dimethylethyl)-4-hydroxybenzene- | |
| | | | index 33 g/10 min at | propanoate | |
| | | | 190° C./2.16 kg) | 1.0% by weight 4-hydroxy-2,2,6,6-tetramethyl- | |
| | | | | piperidine-1-oxyl | |
| F | 7 | 75 | EVA | — | 130 |
| | | | (vinyl acetate content | | |
| | | | 28% by weight, melt | | |
| | | | index 150 g/10 min at | | |
| | | | 190° C./2.16 kg) | | |

TABLE 6
Composition (in kg/h), homogenizing temperature (Tₕₒₘₒ in ° C.), take-off temperature
(T_{off} in ° C.), and mechanical properties of the composite materials (density in
g/cm³, tensile elasticity modulus in GPa), and viscosity of uncrosslinked
compounds (η_{comp} at 130° C. in Pa*s).

| | | | | | | Tensile | |
|---|---|---|---|---|---|---|---|
| | | | | | Density | elasticity | |
| Composition | Blend | Wood | Additive | Tₕₒₘₒ/T_{off} | (g/cm³) | modulus | η_{comp} |
| VIII | 3.5 (A) | 11 | 0.8 (PEG 35 000) | 130/180 | 1.20 | 3.2 | 3.2*10⁴ (at 15.8 s⁻¹) |
| | | | 0.8 (borax) | | | | |
| IX | 5.5 (B) | 11 | PO/EO block polymer with | 130/180 | 1.18 | 3.4 | 2.7*10⁴ (at 17.1 s⁻¹) |
| | | | 50% EO, molecular weight | | | | |
| | | | approx. 6500) | | | | |
| | | | 0.8 ammonium polyphosphate | | | | |
| X | 3.5 (A) | 11 | 0.7 (PEG 35 000) | 130/180 | 1.25 | 4.1 | 3.8*10⁴ (at 16.2 s⁻¹) |
| XI | 5.0 (D) | 11 | 0.5 (PEG 12 000) | 130/170 | 1.20 | 4.2 | 3.1*10⁴ (at 21.6 s⁻¹) |
| | | | 0.2 (EVA batch with 5% peroxide) ^{a} | | | | |
| XII | 4.5 (E) | 11 | 0.3 (PPG 9000) | 130/190 | 1.19 | 3.1 | 2.7*10⁴ (at 16.8 s⁻¹) |
| | | | 0.4 (PEG 12000) | | | | |
| | | | 0.5 (zinc borate) | | | | |
| XIII | 3.0 (F) | 11 | 0.5 (PEG 35 000) | 130/180 | 1.28 | 4.5 | 3.5*10⁴ (at 19.4 s⁻¹) |
| | | | 0.1 (EVA batch with 5% peroxide) [symbol] | | | | |

^{a} di(tert-butylperoxyisopropyl)benzene,
^{b} dibenzoyl peroxide

1-22. (canceled)

23. A composite material with a proportion of wood and with a proportion of crosslinked plastics, the composition comprising from 55 to 90% by weight of wood and from 45 to 10% by weight of crosslinked plastics, where the proportion of wood has been dispersed in the form of particles in the crosslinked plastics, and the crosslinked plastics are crosslinked melamine resin ethers or mixtures composed of from 10 to 90% by weight of partially crosslinked thermoplastics and of from 90 to 10% by weight of crosslinked melamine resin ethers.

24. The composite material as claimed in claim 23, wherein the proportion of wood is present in the form of wood flour, wood particles, wood granules, wood fibers, and/or wood shavings.

25. The composite material as claimed in claim 23, wherein the proportion of wood is in the form of mixtures composed of wood fibers and of wood shavings in a ratio of from 1:10 to 10:1 at from 65 to 80% by weight, and the proportion of crosslinked plastics is from 35 to 20% by weight.

26. The composite material as claimed in claim 23, wherein the crosslinked plastics are mixtures composed of partially crosslinked ethylene-vinyl acetate copolymers whose vinyl acetate content is from 25 to 40% by weight and of crosslinked melamine resin ethers in a mixing ratio of from 2:1 to 1:5.

27. The composite material as claimed in claim 23, further comprising from 3 to 10% by weight of flame retardant, from 0.1 to 2% by weight of pigments, from 0.1 to 5% by weight of stabilizers, and/or from 0.1 to 5% by weight of auxiliaries, in each case based on the entirety of wood and plastics.

28. The composite material as claimed in claim 27, wherein the stabilizers are UV absorbers and/or free-radical scavengers.

29. The composite material as claimed in claim 27, wherein the auxiliaries are lubricants and/or release agents.

30. The composite material as claimed in claim 23, wherein the crosslinked melamine resin ethers and the partially crosslinked thermoplastics are present in foamed form.

31. The composite material as claimed in claim 23, wherein the composite material is present in the form of a sheet, profile, or injection molding.

32. The composite material as claimed in claim 23, wherein the crosslinked melamine resin ethers are crosslinked etherified melamine resin condensates which are free from hydroxymethyleneamino groups bonded to the triazine rings of the melamine resin condensate, and from —NH—CH₂—O—CH₂—NH— groups linking triazine rings, and in which the non-crosslinked etherified melamine resin condensates have been effected via etherification of the hydroxymethylamino groups of the non-etherified melamine resin condensates via C₁-C₁₈ alcohols and/or via polyols of the type represented by diols, triols, and/or tetrols with molecular weights of from 62 to 20 000, and in which the non-crosslinked etherified melamine resin condensates have been hardened thermally and/or via acidifier.

33. The composite material as claimed in claim 23, wherein the partially crosslinked thermoplastics are partially crosslinked ethylene-vinyl acetate copolymers, partially crosslinked partially hydrolyzed ethylene-vinyl acetate copolymers, partially crosslinked thermoplastic polyurethanes, partially crosslinked high-molecular-weight aliphatic and/or aromatic-aliphatic polyethers, and/or partially crosslinked aliphatic and/or aromatic-aliphatic polyesters, preferably partially crosslinked polycaprolactones, and/or unsaturated polyesters.

34. A process for production of a composite material as claimed in claim 23, wherein the composite material is produced by an extruder process, where in a
a) first stage of the process in a first extruder segment a melt mixture composed of melamine resin ethers, wood, and, optionally, thermoplastics is prepared, the melt mixture is devolatilized after homogenization, and, in a second extruder segment, hardener, thermally decomposing free-radical generator, and/or blowing agent are fed into the melt mixture, and are homogenized in the melt mixture, where flame retardants, pigments, stabilizers, and/or auxiliaries are optionally fed in the first and/or second extruder segment, and in a
b) second stage of the process, the wood-containing melt mixture is either heated in a third extruder segment, discharged via a die with crosslinking and, optionally, foaming, and drawn off in the form of a semifinished product, or is discharged from the extruder, and pelletized, and the pellets in a
c) third stage of the process are processed in presses, extruders, or injection-molding machines with crosslinking and, optionally, foaming to give semifinished products or molded materials.

35. The process as claimed in claim 34, wherein the length of the extruders is from 30 to 60 D, the melt mixture in the first extruder segment is prepared at melt temperatures of from 110 to 170° C., the feed in the second extruder segment takes place at melt temperatures of from 100 to 150° C., the heating in the third extruder segment takes place of from 150 to 240° C., and the processing in the third stage of the process takes place at temperatures of from 150 to 240° C.

36. The process as claimed in claim 34, wherein the melt mixture in the first stage of the process is prepared from melamine resin ethers whose weight-average molecular weight is from 1500 to 200 000 and whose molar melamine/formaldehyde ratio is from 1:1.5 to 1:4.

37. The process as claimed in claim 34, wherein, prior to the first stage of the process, wood is impregnated, in mixers, with solutions or dispersions of melamine resin condensates in water or mixtures composed of water and C₁-C₄ alcohols, and is dried, where the melamine resin condensates are etherified melamine resin condensates and/or are melamine resin condensates partially etherified with C₁-C₄ alcohols, the weight-average molecular weights of the condensates being from 150 to 50 000 and their molar melamine/formaldehyde ratio being from 1:1.5 to 1:4, and the melamine resin condensates comprise, optionally, up to 3% by weight of hardener, based on the melamine resin condensates, and then the melt mixture in the first stage of the process composed of the wood pre-impregnated with melamine resins and also of
melamine resin ethers or
thermoplastics or
mixtures composed of melamine resin ethers and thermoplastics
is prepared.

38. The process as claimed in claim 37, wherein the solids content of the solutions or dispersions is from 20 to 80% by weight, the impregnation process takes place at from 80 to 120° C., the length of the extruders is from 30 to 60 D, the melt mixtures in the first extruder segment are prepared at melt temperatures of from 110 to 170° C., the feed in the second extruder segment takes place at melt temperatures of from 100 to 150° C., the heating in the third extruder segment takes place to temperatures of from 150 to 240° C., and the processing in the third stage of the process takes place at temperatures of from 150 to 240° C.

39. A process for production of a composite material as claimed in claim 23, wherein the composite material is produced by a sintering process where in a
a) first stage of the process, mixtures composed of
1) wood and of
2) plastics which are composed of
(i) melamine resin ethers or
(ii) mixtures composed of melamine resin ethers and of thermoplastics, or
(iii) thermoplastics, are sintered in high-speed mixers, the sinter mixture is cooled, and, after cooling, hardeners, thermally decomposing free-radical generators, and/or blowing agents, flame retardants, pigments, stabilizers, and/or auxiliaries are applied to the sinter mixture in the drum mixer, and in a
b) second stage of the process, the sinter mixture comprising wood, and comprising melamine resin ethers and, optionally, comprising thermoplastics is processed in presses, in extruders, or in injection-molding machines, with crosslinking and, optionally, foaming, to give semifinished products or molded materials.

40. The process as claimed in claim 39, wherein the sintering process in the first stage of the process takes place in high-speed mixers with residence times of from 3 to 30 min and final temperatures of from 90 to 180° C., the process of cooling of the sinter mixture takes place to temperatures of from 50 to 120° C., and the processing of the sinter mixture in the second stage of the process takes place at temperatures of from 150 to 240° C.

41. The process as claimed in claim 34, wherein the wood used is in the form of wood flour, wood particles, wood granules, wood fibers, or wood shavings, and comprises from 3 to 10% by weight of sodium borate or sodium borate/boric acid mixtures in a ratio by weight of from 1:9 to 9:1.

42. The process as claimed in claim 34, wherein the hardener used comprises:
A) aliphatic C₄-C₁₈ carboxylic acids;
B) aromatic C₇-C₁₈ carboxylic acids;
C) acidifiers selected from the group consisting of blocked sulfonic acids, alkali metal salts, and ammonium salts of phosphoric acid;
D) C₁-C₁₂ alkyl esters or C₂-C₈ hydroxyalkyl esters of (i) C₇-C₁₄ aromatic carboxylic acids or (ii) inorganic acids;
E) salts of melamine or guanamine with C₁-C₁₈ aliphatic carboxylic acids;
F) anhydrides, half-esters or half-amides of C₄-C₂₀ dicarboxylic acids;
G) half-esters or half-amides of copolymers of (i) ethylenically unsaturated C₄-C₂₀ dicarboxylic anhydrides and (ii) ethylenically unsaturated monomers selected from the group consisting of C₂-C₂₀ olefins, C₈-C₂₀ vinyl aromatics, salts of C₁-C₁₂ alkylamines, and salts of C₁-C₁₂ alkanolamines, and combinations thereof,
wherein said salts of C₁-C₁₂ alkylamines and alkanolamines are with an acid selected from the group consisting of C₁-C₁₈ aliphatic carboxylic acids, C₇-C₁₄ aromatic carboxylic acids, alkylaromatic carboxylic acids, hydrochloric acid, sulfuric acid, phosphoric acid, and combinations thereof.

43. A window, door, cladding element, roof element, garden furniture, outdoor seat or playground comprised of the composite material of claim 23.
